(19) United States
(12) Patent Application Publication
(10) Pub. No.: US 2026/0094878 A1
(43) Pub. Date: Apr. 2, 2026

(54) PRIOR TO REPROCESSING, SHUTTING OFF VOLTAGE POTENTIAL TO CONTACT TERMINALS OF BATTERY HOUSING TO PREVENT CORROSION

(71) Applicant: DePuy Synthes Products, Inc., Raynham, MA (US)

(72) Inventors: David NARDUCCI, Jupiter, FL (US); Eric SCHMITT, Palm Beach Gardens, FL (US)

(21) Appl. No.: 19/307,517

(22) Filed: Aug. 22, 2025

Related U.S. Application Data
(60) Provisional application No. 63/701,028, filed on Sep. 30, 2024.

(51) Int. Cl. H01M 10/42

(52) U.S. Cl. CPC H01M 10/42; H01M 2220/30

(57) ABSTRACT

The disclosed technology herein includes to preventing corrosion during reprocessing (e.g., cleaning and/or sterilization) of a housing for a battery having associated exposed external contact terminals (e.g., communication contact terminals and non-communication contact terminals) and is physically connectable to a secondary device. The voltage potential to the exposed external contact terminals is shut off when the housing is determined to be: (i) physically inactive for a predetermined period of time based on monitored motion of the housing by at least one sensor; (ii) physically inactive for the predetermined period of time based on monitored motion of the housing by the at least one sensor and not in active communication with the secondary device; or (iii) physically disconnected from the secondary device. While the voltage potential is shut off to the exposed external contact terminals, reprocessing of the housing is initiated.

### CROSS REFERENCE TO RELATED APPLICATIONS

This application claims the benefit of priority under 35 U.S.C. § 119 to prior filed U.S. Provisional Patent Application No. 63/701,028, filed Sep. 30, 2024 (Attorney Docket No.: 267214.000003 (DSP6437USPSP1)), the entire contents of which is hereby incorporated by reference in its entirety as if set forth in full herein.

### FIELD

The present disclosure generally relates to a housing enclosing a battery (i.e., battery pack) physically connectable (i.e., physically installable) on a secondary device (e.g., charger or hand-held power tool for performing an operation). In particular, the present disclosure is directed to a method for preventing corrosion by, prior to initiating reprocessing (e.g., cleaning and/or sterilization to prevent corrosion of exposed external contact terminals), shutting off voltage potential supplied to the exposed external contact terminals of a housing of the battery when the housing of the battery is determined to be: (i) physically inactive (i.e., at rest or lack of motion) for a predetermined of time; (ii) physically inactive (i.e., at rest or lack of motion) for a predetermined of time and not in active electrical communication with the secondary device; or (iii) physically disconnected (i.e., uninstalled) from a secondary device (e.g., charger or hand-held power tool). Several example methods by which it is determined whether the housing of the battery is in motion and/or physically disconnected from the secondary device (e.g., charger or hand-held power tool) are described and illustrated herein.

### BACKGROUND

In the field of orthopedics, hand-held power tools performing a variety of orthopedic operations (e.g., drilling, sawing or impacting) are often used during surgical joint replacement procedures (e.g., knee or hip replacement). Powered orthopedic tools provide high accuracy and efficiency in comparison to manual orthopedic tools. These hand-held tools typically include a handpiece powered by a battery pack (i.e., at least one battery within a housing). The housing (including at least one battery housed or enclosed therein) when properly installed on (i.e., releasably connected to or releasably attached to) the handpiece allows the hand-held power tool to operate.

Currently, during reprocessing, e.g., cleaning or sterilization, the exposed external contact terminals of batteries enclosed within a housing are highly susceptible to corrosion through electrolytic reaction. This corrosion creates a barrier during establishment of an electrical connection when installing (i.e., releasably attaching or releasably connecting) the housing of the battery on the secondary device (e.g., a charger or a hand-held power tool such as a hand-held powered orthopedic tool) preventing altogether or hampering optimum acceptance of charge or powering/operation of the power tool. Specifically, an oxide layer forms on an outer surface of the exposed external contacts of the housing of the battery. Over time, the electrolytic reaction breaks down the contact plating exposing the base material, typically copper, causing it to corrode.

It is desirable to develop a system and method to prevent corrosion by, prior to initiating reprocessing (e.g., cleaning and/or sterilization), shutting off the voltage potential to exposed external contact terminals of the housing of the battery when the housing of the battery is determined to be: (i) physically inactive (i.e., at rest or lack of motion) for a predetermined of time; (ii) physically inactive (i.e., at rest or lack of motion) for a predetermined of time and not in active electrical communication with the secondary device; or (iii) physically disconnected from (i.e., not physically installed on) a secondary device (e.g., charger or hand-held power tool).

### SUMMARY

An aspect of the present disclosure is directed to preventing corrosion by, prior to initiating reprocessing (e.g., cleaning and/or sterilization), shutting off the voltage potential to exposed external contact terminals of the housing of the battery.

Another aspect of the present disclosure relates to preventing corrosion by, prior to initiating reprocessing (e.g., cleaning and/or sterilization), shutting off the voltage potential to exposed external contact terminals of the housing of the battery when the housing of the battery is determined to be: (i) physically inactive (i.e., at rest or lack of motion) for a predetermined of time; (ii) physically inactive (i.e., at rest or lack of motion) for a predetermined of time and not in active electrical communication with the secondary device; or (iii) physically disconnected from (i.e., not physically installed on) the secondary device (e.g., charger or hand-held power tool).

Still another aspect of the present disclosure relates to preventing corrosion by, prior to initiating reprocessing (e.g., cleaning and/or sterilization), shutting off the voltage potential to exposed external contact terminals of the housing of the battery when the housing of the battery is determined to be physically inactive (i.e., at rest or lack of motion) for a predetermined period of time, wherein physical inactivity is determined by monitoring motion of the housing of the battery using at least one sensor (e.g., accelerometer, gyroscope, magnetometer, etc.).

Yet another aspect of the present disclosure relates to preventing corrosion by, prior to initiating reprocessing (e.g., cleaning and/or sterilization), shutting off the voltage potential to exposed external contact terminals of the housing of the battery when the housing of the battery is determined to be physically inactive (i.e., at rest or lack of motion) for a predetermined period of time and not in active electrical communication with the secondary device (e.g., charger or hand-held power tool).

Another aspect of the present disclosure relates to preventing corrosion by, prior to initiating reprocessing (e.g., cleaning and/or sterilization), shutting off the voltage potential to exposed external contact terminals of the housing of the battery when the housing of the battery is determined to be physically disconnected from the secondary device (e.g., charger or hand-held power tool) using a Hall sensor and a magnet.

Yet another aspect of the present disclosure relates to preventing corrosion by, prior to initiating reprocessing (e.g., cleaning and/or sterilization), shutting off the voltage potential to exposed external contact terminals of the housing of the battery when the housing of the battery is determined to be physically disconnected from the secondary device (e.g., charger or hand-held power tool) in that an electrical circuit supplying voltage to associated communication contact terminals remains open (i.e., incomplete) via spring loaded pins.

### BRIEF DESCRIPTION OF THE DRAWINGS

The above and further aspects of this present disclosure are further discussed with reference to the following description in conjunction with the accompanying drawings, in which like numerals indicate like structural elements and features in various figures. The drawings are not necessarily to scale, emphasis instead being placed upon illustrating principles of the present disclosure. The figures depict one or more implementations of the inventive devices, by way of example only, not by way of limitation.

FIG. 1A is a side view of an example orthopedic hand-held power tool in accordance with the present disclosure including a housing with the battery enclosed therein installed on the handpiece;

FIG. 1B is a side view of an example of the housing with the battery enclosed therein installed on a charger;

FIG. 2A is bottom perspective exploded view of the example housing of the battery with the electronic printed circuit board assembly including at least one sensor for tracking motion of the housing of the battery;

FIG. 2B is a top perspective view of the housing of the battery of FIG. 2A depicting the exposed external contact terminals;

FIG. 2C is an exemplary schematic electronic circuitry diagram of the housing of the battery in accordance with the present disclosure;

FIG. 3A is a top perspective view of another example housing of the battery wherein determining whether the housing of the battery is physically disconnected (i.e., uninstalled) from the secondary device (e.g., charger or hand-held power tool) uses a Hall sensor disposed internally of the housing of the battery and an external actuating member (e.g., sliding switch) displacing a magnet attached thereto together disposed externally of the housing of the battery;

FIG. 3B is a cutaway side view of the interior of the housing of the battery of FIG. 3A showing positioning of the actuating member together with the magnet in a non-activated state furthest away from the Hall sensor disposed internally of the housing of the battery;

FIG. 3C is a cutaway side view of the interior of the housing of the battery of FIG. 3A showing positioning of the actuating member together with the magnet in an activated state (i.e., fully displaced) closest to the Hall sensor disposed internally of the housing of the battery;

FIG. 4A is a partial lateral cross-sectional view through the exposed external contact terminals of still another example housing of the battery having spring-loaded communication electrical contracts used to complete an electrical circuit to determine whether the housing of the battery is physically connected to (i.e., installed on) the secondary device; wherein the housing of the battery is depicted physically disconnected from the secondary device (e.g., charger or hand-held power tool) with electrical moveable members (e.g., spring-loaded pins) in a default, non-displaced, extended state and the electrical circuit to the corresponding communication contact terminals incomplete (i.e., open circuit) cutting off power thereto;

FIG. 4B is a partial lateral cross-sectional view through the exposed external contact terminals of the respective housing of the battery and secondary device of FIG. 4A depicted physically connected to one another; wherein the spring-loaded pins are in a displaced, compressed state completing (i.e., closing) the electrical circuit to the corresponding communication contact terminals of the housing of the battery providing power thereto ensuring uninterrupted communication between the devices when physically connected to one another;

FIG. 4C is a partial lateral cutaway perspective view through the exposed external contact terminals of the respective housing of the battery and secondary device depicted physically disconnected from one another with the spring-loaded pins in the non-displaced, extended state and the electrical circuit to the corresponding communication contact terminals incomplete (i.e., open circuit) without power supplied thereto;

FIG. 4D is a partial lateral cutaway perspective view through the exposed external contact terminals of the respective housing of the battery and second device of FIG. 4A physically connected to one another with the spring-loaded pins in the displaced, compressed state completing (i.e., closing) the electrical circuit to the corresponding communication contact terminals of the housing of the battery supplying powering thereto and ensuring uninterrupted communication between the two devices when physically connected to one another; and

FIG. 5 is a flow chart of the method of preventing corrosion, prior to initiating reprocessing (e.g., cleaning and/or sterilization to prevent corrosion) of the housing of the battery, by shutting off voltage potential to the exposed external contact terminals when the housing of the battery is determined to be: (i) physically inactive (i.e., at rest or lack of motion) for a predetermined of time; (ii) physically inactive (i.e., at rest or lack of motion) for a predetermined of time and not in active electrical communication with the secondary device (e.g., charger or hand-held power tool); or (iii) physically disconnected from (i.e., not physically installed on) a secondary device (e.g., charger or hand-held power tool).

### DETAILED DESCRIPTION

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g. “about 90%” may refer to the range of values from 71% to 99%.

As used herein, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal. Computer readable medium can be non-transitory. Non-transitory computer-readable media include, but are not limited to, random access memory (RAM), read-only memory (ROM), electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store computer readable instructions and/or data.

As used herein, the term “computing system” is intended to include stand-alone machines or devices and/or a combination of machines, components, modules, systems, servers, processors, memory, detectors, user interfaces, computing device interfaces, network interfaces, hardware elements, software elements, firmware elements, and other computer-related units. By way of example, but not limitation, a computing system can include one or more of a general-purpose computer, a special-purpose computer, a processor, a portable electronic device, a portable electronic medical instrument, a stationary or semi-stationary electronic medical instrument, or other electronic data processing apparatus.

As used herein, the term “non-transitory computer-readable media” includes, but is not limited to, random access memory (RAM), read-only memory (ROM), electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store computer readable information.

Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

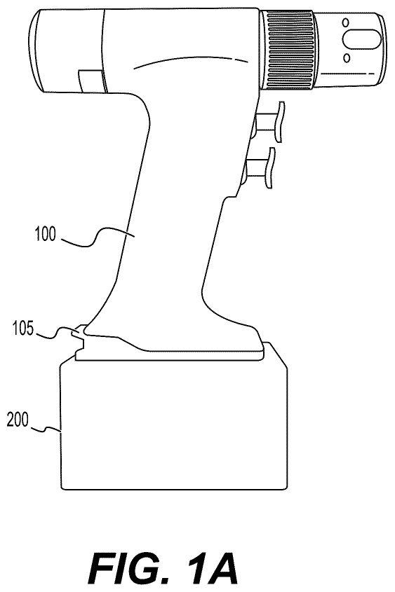

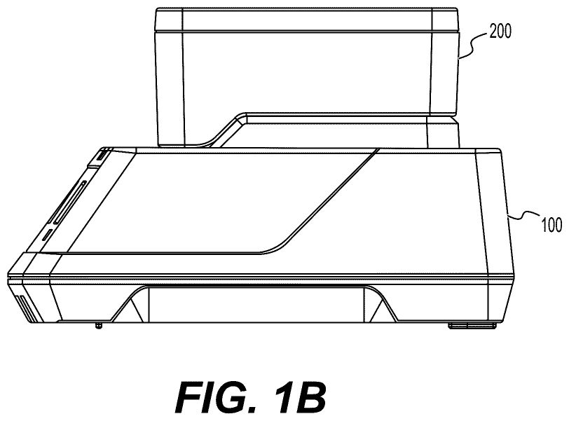

The present disclosure is directed to a system and method of preventing corrosion by, prior to initiating reprocessing (e.g., cleaning or sterilization to prevent corrosion) of the housing enclosing a battery therein (i.e., battery pack or battery housing), shutting off the voltage potential to the exposed external contact terminals when the housing of the battery is determined to be: (i) physically inactive (i.e., at rest or lack of motion) for a predetermined of time; (ii) physically inactive (i.e., at rest or lack of motion) for a predetermined of time and not in active electrical communication with the secondary device; or (iii) physically disconnected from (i.e., not physically installed on) the secondary device (e.g., charger or hand-held power tool). Preferably the battery is rechargeable to allow repeated use of the same housing and battery therein. Nevertheless, single use (i.e., non-rechargeable) batteries are also contemplated. Any number of one or more batteries may be disposed in the housing, as desired. The housing with the battery (e.g., rechargeable or single use (i.e., non-rechargeable)) enclosed therein is releasably installed on (i.e., releasably attached to or releasably connected to) another device hereinafter referred to as a secondary device 100 such as a charger to recharge the battery or a hand-held power tool that is powered by the battery. By way of example, the hand-held power tool illustrated and described herein is an orthopedic hand-held power tool used during surgical replacement procedures, typically hip or knee replacement. For purposes of illustration and description of the present disclosure the orthopedic operation performed by the orthopedic hand-held power tool may be drilling, reaming, oscillation drilling, sagittal sawing, reciprocating sawing, oscillating sawing or impacting depending on the interchangeable tool heads attachable thereto. Any operation may be performed by the power tool depending on the tool head. FIG. 1A is a side view of an orthopedic hand-held power tool 100 with the battery housing 200 (i.e., battery pack) installed thereon (i.e., attached or connected thereto) powering the tool. The example orthopedic hand-held power tool in FIG. 1A has two triggers independently operable of one another. For example, one trigger controls (i.e., varying or adjusting) the operating speed of the tool head in the forward direction, while the other trigger controls the operating speed of the tool head in the reverse direction. Alternatively, a single trigger control may be used to control (i.e., varying or adjusting) the operating speed and the direction (e.g., forward or reverse) selectable via a separate button, switch or dial. The direction and speed by which the operation of the tool head is controlled may be configured, as desired, using any number of triggers, buttons, switches, knobs, etc. FIG. 1B is a side view of the battery housing 200 (i.e., battery pack) physically connected to (i.e., physically installed on) a charging device 100.

When the housing 200 of the battery is properly physically connected to (i.e., physically installed on) the secondary device 100 (e.g., charger or hand-held power tool) the complementary configured exposed external electrical contact terminals associated with each device 200, 100 engage (i.e., connect) with one another. Reprocessing includes cleaning or sterilization of each of the hand-held power tool 100 and the housing 200 with the battery 205 enclosed therein. Cleaning typically involves subjecting the components to a cleaning detergent (e.g., an enzymatic detergent representing a composition of one or more enzymes (e.g., protease, lipase or amylase enzyme). The detergent may take the form of a liquid composition, a powder composition, a gel composition or any combination thereof. During cleaning or sterilization, the exposed external electrical contact terminals of the housing 200 with the battery 205 enclosed therein are at significant risk of corrosion due to electrolytic reaction. The present disclosure provides a method of preventing corrosion by, prior to initiating reprocessing (e.g., cleaning or sterilization), shutting off (i.e., cutting off, terminating, or cease applying) the voltage potential to the exposed external contact terminals (e.g., communication terminals and/or power terminals) of the battery housing 200 when the housing of the battery is determined to be: (i) physically inactive (i.e., at rest or lack of motion) for a predetermined of time; (ii) physically inactive (i.e., at rest or lack of motion) for a predetermined of time and not in active electrical communication with the secondary device; or (iii) physically disconnected from (i.e., not physically installed on) a secondary device (e.g., charger or hand-held power tool). Without the voltage potential across the exposed external contact terminals of the housing 200 of the battery, electrolytic reaction is averted during subsequent reprocessing (e.g., cleaning or sterilization) thereby preventing corrosion. In the examples illustrated and described herein, the exposed external electrical contact terminals associated with the housing 200 of the battery include: two communication terminals (e.g., “RX” receiving contact terminal 245b and “TX” transmitting contact terminal 245c) used to communicate (e.g., transmit and receive information) with the secondary device (e.g., charger or hand-held power tool) and two power contact terminals (e.g., “−” negative contact terminal accepting power/charge from the charger 245a and “+” positive contact terminal delivering power to the hand-held power tool 245d). Despite four exposed external contact terminals being illustrated and described, the number may be selected, as desired. The communication contact terminals are lower voltage terminals relative to the higher voltage power contact terminals.

To prevent corrosion, prior to initiating reprocessing (e.g., cleaning or sterilization), the voltage potential to the exposed external contact terminals is shut off when the housing 200 of the battery is determined to be: (i) physically inactive (i.e., at rest or lack of motion) for a predetermined period of time: (ii) physically inactive (e.g., at rest or lack of motion) for a predetermined period of time and not in active electrical communication with the secondary device 100 or (iii) physically disconnected (i.e., disassembled or uninstalled) from the secondary device 100. Each of these three aspects of the present disclosure are described in detail below.

Prior to initiating reprocessing (e.g., cleaning or sterilization), the voltage potential may be shut off to the exposed external contact terminals of the housing 200 of the battery when the housing of the battery 200 is determined to be physically inactive (i.e., at rest or lack of motion) for a predetermined period of time. Therefore, shutting off the voltage potential to the exposed external contact terminals of the housing 200 of the battery occurs in response to satisfaction of a single pre-condition, i.e., physical inactivity for a predetermined period of time of the housing 200 of the battery. Accordingly, physical activity (i.e., motion or movement) of the housing of the battery 200 is monitored over time. By monitoring motion or movement, physical inactivity (i.e., at rest or lack of motion) of the housing 200 of the battery for a predetermined period of time may be detected or determined. Selecting, as desired, the predetermined period of physical inactivity may be based on any number of factors including, but not limited to, the response time for the battery/batteries to wake from a shut-off (i.e., powered down) state. The slower the response time to wake from a shut-off (i.e., powered down) state, the longer the selected period of physical inactivity (i.e., at rest or lack of motion), for instance, as long as approximately two or more minutes. Preferably, the predetermined period of physical inactivity ranges from approximately 5 seconds to approximately 2 minutes. Other factors may also be considered when selecting the desired period of physical inactivity.

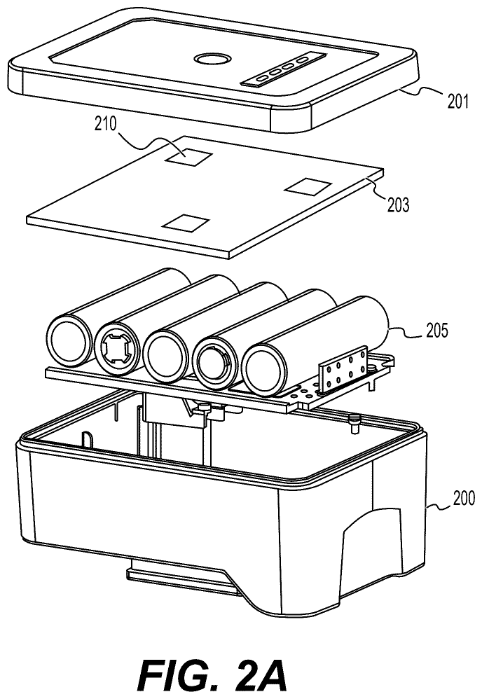

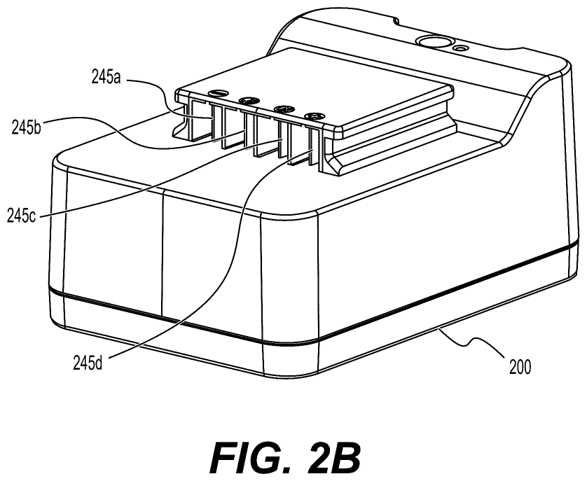

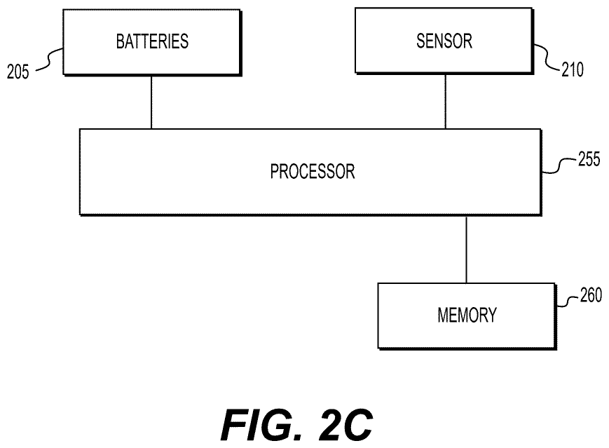

Referring to FIGS. 2A-2C, motion or movement over time of the housing 200 of the battery may be tracked (i.e., monitored) using one or more sensors 210 (e.g., Inertial Measurement Unit (IMU), accelerometer(s), gyroscope(s) and/or magnetometer(s)). Motion may be monitored via the sensor(s) 210 along a single axis or along each of multiple axes (e.g., along each of three axes, namely the x-axis, the y-axis and the z-axis). FIG. 2A is an exploded view of the example battery housing 200 including the batteries 205 and electronic circuit board 203 with the sensor 210 and other electronic components/modules mounted thereto. In the example electronic schematic in FIG. 2C the electronic components mounted to the electronic circuit board 203 associated with the housing 200 of the battery include a processor/controller 255, a memory device 260, at least one sensor 210 for tracking (i.e., monitoring) motion. Additional electronic components may be included.

FIG. 2B is a top perspective view of the example battery housing 200 having four exposed external contact terminals 245 (e.g., “−” negative terminal 245a, “RX” receiver terminal 245b, “TX” transmitter terminal 245c, “+” positive terminal 245d). Secondary device 100 (e.g., charger or hand-held power tool) has four complementary configured exposed external contact terminals. When the housing 200 of the battery is properly installed on (i.e., releasably attached to or releasably connected to) the secondary device 100 the respective exposed external contact terminals physically engage one another creating an electrical connection to allow powering, communication and/or operation between the devices 100, 200. The housing 200 of the battery is releasably detached or releasably disconnected from the secondary device 100 via a release mechanism 105 (e.g., a releasable mechanical latch) (FIG. 1A).

In operation, when the housing 200 of the battery is determined to be physically inactive for a predetermined period of time while being tracked using the sensor 210, the voltage potential is shut off to the exposed external contact terminals of the housing 200 of the battery. During this period in which the power is cut off to the exposed external contact terminals of the housing 200 of the battery, reprocessing (e.g., cleaning or sterilization) may be initiated without electrolytic reaction thereby preventing corrosion. Thereafter, in response to the sensor 105 tracking motion or movement of the housing 200 of the battery, reprocessing ceases and the voltage potential is supplied (e.g., resumes) to the external contact terminals of the housing 200 of the battery. Upon detecting motion of the housing 200 of the battery voltage may be supplied either: (i) simultaneously to all the exposed external contact terminals of the housing of the battery; or (ii) sequentially in stages to the exposed external contact terminals of the housing of the battery. In the former scenario, when activated by motion, the voltage potential is supplied simultaneously to all contact terminals including both communication contact terminals (e.g., “TX” transmitting contact terminal and “RX” receiving contact terminal) and power contact terminals (e.g., “+” positive contact terminal and “−” negative contact terminal). Whereas, in the latter scenario, for example, when activated by motion, voltage may be supplied to the exposed external contact terminals in two sequential stages. That is, in a first stage the voltage potential is supplied to the communication contact terminals (e.g., “TX” transmitting contact terminal and “RX” receiving contact terminal) restoring communication and in a subsequent second stage the voltage potential is supplied to the power contact terminals.

Battery housing 200 may be physically active (i.e., in motion or not at rest) in a variety of situations. For example, the housing 200 of the battery may be physically active while being installed on the secondary device 100 (e.g., charger or hand-held power tool). Once installed the housing 200 of the battery is physically active during at least a portion of the treatment procedure while operating the hand-held power tool. While installed on (i.e., attached to or connected to) the secondary device 100 the housing 200 of the battery may, nevertheless, be physically inactive if unintentionally left on overnight thereby undesirably depleting/discharging the batteries. In the example in which physical inactivity (i.e., at rest or lack of motion) for a predetermined period of time of the housing of the battery is the single (i.e., sole, only or exclusive) pre-condition for shutting off the voltage potential to the exposed external contact terminals, then such depletion or discharge of the batteries would be averted by cutting off the power to the exposed external contact terminals. Only when the motion sensor 210 detects motion or movement of the housing 200 of the battery 200 would the voltage potential once again be supplied to the exposed external contact terminals to allow powering and/or communication with the secondary device 100.

Unintentional interruption in powering and/or communication of the secondary device 100 (e.g., charger or hand-held power tool) while installed on the housing 200 of the battery may be experienced if the voltage potential to the exposed external contact terminals of the housing of the battery is shut off based solely on physical inactivity (i.e., at rest or lack of motion) of the housing 200 of the battery for a predetermined period of time. For instance, during charging of the battery 205 while properly installed on the charging device 100, the housing 200 of the battery is typically at rest (i.e., physically inactive). If such period of physical inactivity or rest persisted for the predetermined period of time, then the voltage potential to the exposed external contact terminals of the housing 200 of the battery would be shut off causing unintentional interruption in the charging of the battery 205. In another example situation, during operation of the hand-held power tool 100, the housing 200 of the battery installed thereto may undergo a period of physical inactivity while the user operates another tool or views imaging of the treatment site. Powering of and/or communication with the hand-held power tool may be unintentionally interrupted if the voltage potential to the exposed external contact terminals of the housing 200 of the battery is shut off based solely on physical inactivity (i.e., at rest or lack of motion) of the housing 200 of the battery for a predetermined period of time. To avert such unintentional interruption, in an alternative example in accordance with the present disclosure, an optional second pre-condition may also have to be satisfied prior to shutting off the voltage potential to the exposed external contact terminals of the housing 200 of the battery. In this alternative example, the voltage potential to the exposed external contact terminals is not shut off until the housing 200 of the battery satisfies both pre-conditions: (i) physical inactivity (i.e., at rest or lack of motion) for a predetermined period of time; and (ii) not in active electrical communication with the secondary device 100 (e.g., charger or hand-held power tool). For example, active electrical communication includes the housing 200 of the battery receiving electrical communication (i.e., charge) from the charger or active electrical communication while operating the hand-held power tool. Despite detecting physical inactivity for a predetermined period of time, if the housing 200 of the battery is in active electrical communication with the secondary device 100 power nevertheless continues to be supplied to at least the communication contact terminals thereby averting unintentional interruption in communication between the devices. In such scenario, the non-communication contact terminals (e.g., +/−power contact terminals) of the battery housing 200 may also remain powered on or, alternatively, the voltage potential may be shut off (e.g., via a discharge Field Effect Transistor (FET)).

Thereafter, when motion (i.e., physical activity or movement) of the housing 200 of the battery is detected by the sensor 105, reprocessing ceases (i.e., terminates) and the voltage potential is supplied (e.g., resumed or returned) to the exposed external contact terminals of the housing 200 of the battery. Upon detecting motion of the housing 200 of the battery voltage may be supplied either: (i) simultaneously to all the exposed external contact terminals of the housing of the battery; or (ii) sequentially in stages to the exposed external contact terminals of the housing of the battery. In the former scenario, when activated by motion, the voltage potential is supplied simultaneously to all contact terminals including both communication contact terminals (e.g., “TX” transmitting contact terminal and “RX” receiving contact terminal) and power contact terminals (e.g., “+” positive contact terminal and “−” negative contact terminal). Whereas, in the latter scenario, for example, when activated by motion, voltage may be supplied to the exposed external contact terminals in two sequential stages. That is, in a first stage the voltage potential is supplied to the communication contact terminals (e.g., “TX” transmitting contact terminal and “RX” receiving contact terminal) restoring communication and in a subsequent second stage the voltage potential is supplied to the power contact terminals.

A different pre-condition to the shutting off of the voltage potential to the exposed external contact terminals of the housing of the battery may be based instead on the housing 200 of the battery being determined to be physical disconnected (i.e., uninstalled) from the secondary device 100 (e.g., charger or hand-held power tool). Different ways are possible to determine whether the housing 200 of the battery is physically disconnected (i.e., uninstalled) from the secondary device 100, several examples are shown and described herein.

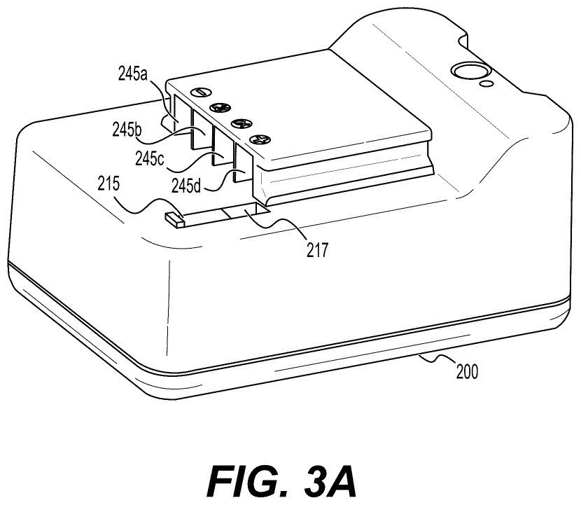

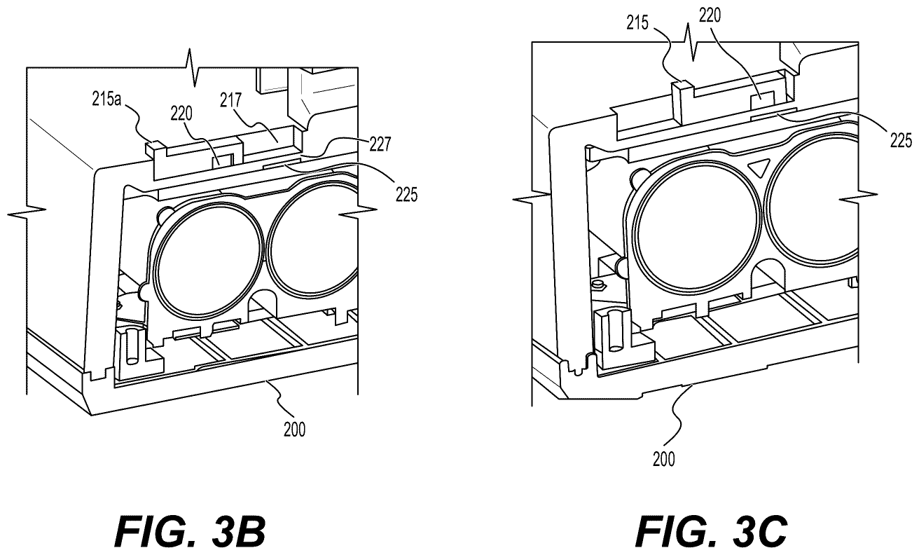

The example shown in FIGS. 3A-3C uses a Hall sensor 225 and a moveable magnet 220 to determine whether the housing 200 of the battery is physically disconnected (i.e., uninstalled) from the secondary device 100 (e.g., charger or hand-held power tool). Referring to the top perspective view in FIG. 3A, the example housing 200 of the battery has four exposed external contact terminals (e.g., “−” negative terminal 245a, “RX” receiver terminal 245b, “TX” transmitter terminal 245c, and “+” positive terminal 245d). In addition, the housing 200 of the battery includes an actuating member 215 together with the associated magnet 220 secured thereto displaceable (i.e., moveable) relative to the Hall sensor 225. Actuating member 215 (e.g., slidable switch) is preferably spring-loaded and includes an engaging element 215a (e.g., raised portion). In the example depicted in FIGS. 3A-3C, by default, the spring-loaded actuating member 215 and associated magnet 220 remain in the non-activated state (i.e., not displaced state) when the housing 200 of the battery is physical disconnected (i.e., uninstalled or detached) from the secondary device 100. In the example of FIGS. 3A-3C while in the non-activated state, the magnet 220 is positioned furthest away from a Hall sensor 225 disposed interiorly of the housing 200 of the battery. When the housing 200 of the battery is installed on the secondary device 100, the engaging element 215a is displaced advancing the actuating member 215 together with the associated magnet 220 secured thereto from a default non-activated state (i.e., not displaced state) to an activated state (i.e., fully displaced state) positioned closest to (e.g., substantially aligned with) the Hall sensor 225. In the activated state (i.e., fully displaced state), the magnet 220 is positioned closest to the Hall sensor 225. Accordingly, positioning of the magnet 220 relative to the Hall sensor 225 is the basis for determining whether the housing of the battery 200 is physically disconnected (i.e., uninstalled) from the secondary device 100. Specifically, in the example of FIGS. 3A-3C, when the housing of the battery 200 is physically connected (i.e., installed) on the secondary device 100, the magnet 220 is in an activated state (i.e., fully displaced state) positioned closest to the Hall sensor 225 (FIG. 3C), whereas by default, when the housing 200 of the battery is physically disconnected (i.e., uninstalled or detached) from the secondary device 100, the magnet 220, by default, remains in the non-activated state (i.e., not displaced state) positioned furthest from the Hall sensor 225 (FIG. 3B). Alternatively, the opposite configuration is also possible, wherein in the non-activated state the magnet 220 is positioned closest to (e.g., substantially aligned with) the Hall sensor 225 and in the activated state the magnet 220 is positioned furthest away from the Hall sensor 225. To prevent corrosion, in advance of initiating reprocessing (e.g., cleaning or sterilization), the voltage potential is shut off to the exposed external contact terminals of the housing 200 of the battery when it is determined that the housing 200 of the battery is physically disconnected (i.e., uninstalled or detached) from the secondary device depending on the positioning of the magnet 220 relative to the Hall sensor 225. In the example of FIGS. 3A-3C, the magnet 220 when positioned closest to the Hall sensor 225 (e.g., non-activated state) is indicative of the housing 200 of the battery physically connected (i.e., installed) on the secondary device 100. That way, irrespective of physical inactivity of the housing 200 of the battery, voltage potential continues nevertheless to be supplied at least to some of the contact terminals (e.g., communication contact terminals) while the housing 200 of the battery is physically connected (i.e., installed) on the secondary device 100 averting unintentional interruption in powering, communication and/or operation between the devices. While the housing 200 of the battery is physically connected (i.e., installed) on the secondary device 100 and the communication contact terminals remain powered, optionally voltage potential may be shut off to the non-communication contact terminals (e.g., power contact terminals) via a discharge Field Effect Transistor (FET).

In the example depicted in FIGS. 3A-3C, the actuating member 215 is displaceable within an external recess or depression 217 defined along an exterior surface of the housing 200 of the battery with the engaging element 215a along an exterior surface of the actuating member 215 projecting away from the interior of the housing 200 of the battery and the magnet 220 having an exposed surface facing towards the interior of the housing 200 of the battery. The Hall sensor 225 is integrated into an internal recess or depression 227 defined along an interior surface of the housing of the battery 200, wherein the external and internal recesses 217, 227, respectively, are separate and independent of one another (i.e., free from any opening, aperture, hole, channel or passageway defined or connecting the recesses 217, 227, respectively). Hall sensor 225 may alternatively be incorporated into the printed circuit board assembly 203.

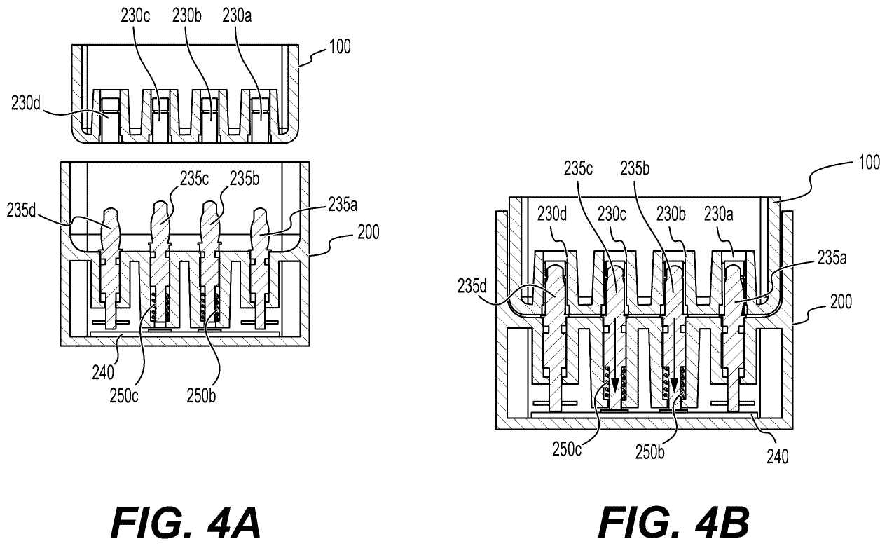

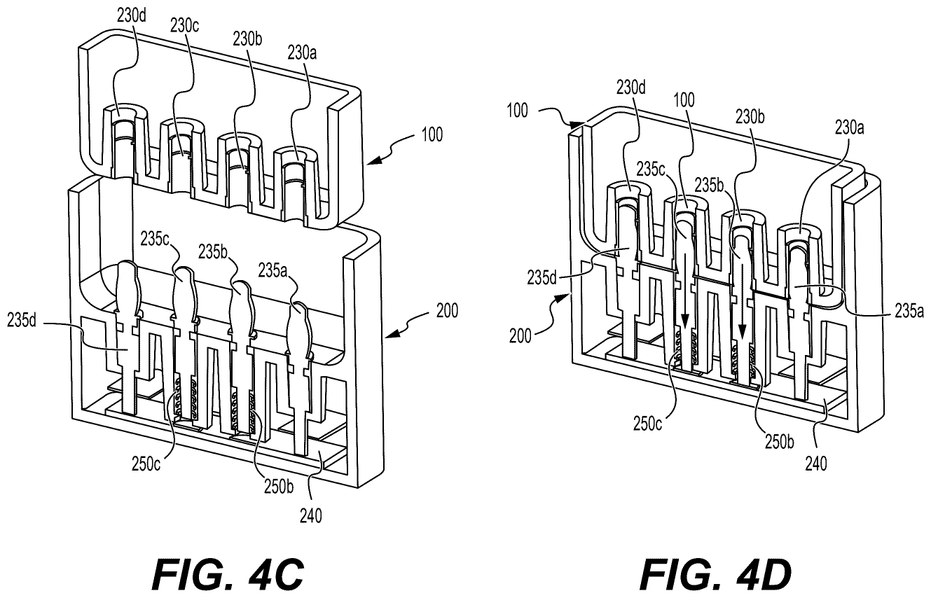

FIGS. 4A-4D depict yet another way to shut off voltage potential to at least the communication contact terminals, possibly all contact terminals, of the housing 200 of the battery when physically disconnected (i.e., uninstalled or detached) from the secondary device 100. Spring loaded contacts automatically shut off the voltage potential to associated communication contact terminals of the housing 200 of the battery when physically disconnected (i.e., uninstalled) from the secondary device 100 (i.e., the electrical circuit to the communication contact terminals remains open (i.e., incomplete) cutting off power thereto). On the other hand, while the housing 200 of the battery is physically connected (i.e., installed) on the secondary device 100 the spring-loaded contacts displace respective springs closing the corresponding electrical circuits to the communication terminals making certain that communication between the devices remains uninterrupted.

Referring to the example in FIGS. 4A-4D, the power contact terminals (“_” negative contact terminal and “+” positive contact terminal) of the housing 200 of the battery have associated electrical stationary members (e.g., stationary pins) 235a, 235d, respectively. A second end of the associated electrical stationary members (e.g., stationary pins) 235a, 235d at all times (regardless of whether installed on the secondary device 100 or not) is in direct physical contact with an electrical contact 240 (e.g., plate shaped component on a printed circuit board assembly) disposed interiorly of the housing 200 of the battery completing (i.e., closing) the electrical circuit to the −/+power contact terminals. While each of the communication contact terminals (“RX” receiving contact terminal and “TX” transmitting contact terminal) associated with the housing 200 of the battery have respective electrical moveable members 235b, 235c (e.g., spring-loaded pins). In a default, non-activated state (i.e., not displaced state) a second end of the respective electrical moveable members (e.g., spring-loaded pins) 235b, 235c are separated a predetermined distance from the electrical contact 240 and in an activated state (i.e., fully displaced state) the second ends of the respective electrical moveable members (e.g., spring-loaded pins) 235b, 235c are in direct physical contact with the electrical contact 240. This default, non-displaced, non-activated state of the electrical moveable members (e.g., spring-loaded pins) 235b, 235c associated with the communication contact terminals may be realized using other components such as compression springs, leaf spring or spring clips.

While the housing 200 of the battery is physically disconnected (i.e., uninstalled) from the secondary device 100, the electrical moveable members 235b, 235c (e.g., spring-loaded pins) are in the default, non-activated state (i.e., not displaced state) with the respective second end separated a predetermined distance relative to an electrical contact 240 (e.g., plate) therefore not completing (i.e., leaving open) the electric circuit to the exposed external communication contact terminals cutting off power thereto. Since the housing 200 of the battery is physically disconnected (i.e., uninstalled) from the secondary device 100 and the electric circuit is incomplete or open cutting off the voltage potential to all the exposed external contact terminals reprocessing (e.g., cleaning or sterilization) may be initiated without risk of corrosion. On the other hand, while the housing 200 of the battery is physically connected (i.e., installed) on the secondary device 100, first ends of the electrical moveable members (e.g., spring-loaded pins) 235a, 235b, 235c, 235d associated with the housing 200 of the battery are received within respective electrical connectors (e.g., complementary shaped receptacle connectors) 230a, 230b, 230c, 230d associated with the secondary device 100. The electrical moveable members (e.g., spring-loaded pins) 235b, 235c, once received within the respective electrical connectors (e.g., complementary shaped receptacle connectors) 230b, 230c, are subjected to sufficient additional force (i.e., continued or additional pushing of the secondary device 100) compressing the associated springs 250b, 250c interiorly within the housing 200 of the battery transitioning to a fully displaced state in which the respective second ends of the electrical moveable members 235b, 235c (e.g., spring-loaded pins) directly physically contact the electrical contact 240 (e.g., plate) completing or closing the electrical circuit. Thus, continued powering of the communication contact terminals while the housing 200 of the battery is physically connected to (i.e., installed on) the secondary device 100 sustains uninterrupted communication between the devices 100, 200. Contact terminals 235a, 235b, 235c, 235d associated with the housing 200 of the battery and complementary electrical connectors 230a, 230b, 230c, 230d associated with the secondary device 100 may differ from that illustrated in the example of FIGS. 4A-4C to be any desired geometry/shape, spring type, angle of insertion, etc.

In operation, while the devices 100, 200 are not installed to one another (i.e., physically disconnected), the electrical moveable members (e.g., spring-loaded pins) 235b, 235c remain in a default, non-activated state via the springs 250b, 250c, respectively, so that the electrical circuit remains open (i.e., incomplete or not closed) to the communication contact terminals of the housing 200 of the battery. Therefore, when not installed on (i.e., physically disconnected from) the secondary device 100 the voltage potential is shut off to all the exposed external contact terminals of the housing 200 of the battery. On the other hand, when the housing 200 of the battery is installed on (i.e., physically connected to) the secondary device 100, electrical moveable members (e.g., spring-loaded pins) 235b, 235c in the activated, fully displaced state close the electric circuits powering the communication contact terminals thereby ensuring uninterrupted communication between the devices 100, 200. Thus, while installed on the secondary device 100, the communication contact terminals remain powered, however, the voltage potential to the non-communication contact terminals (e.g., “+” positive contact terminal and “−” negative contact terminal) may optionally be shut off (e.g., via a discharge Field Effect Transistor (FET).

In summary, voltage potential is shut off to all the exposed external contact terminals when the housing 200 of the battery is physically disconnected (i.e., not installed) on the secondary device 100. It is the completed or closed electrical circuits when the devices 100, 200 are physically connected to one another that sustains powering of the communication contact terminals of the housing 200 of the battery averting interruption of communication between the two devices 100, 200. While power is sustained to the communication terminals when the housing 200 of the battery is installed on the secondary device 100, the voltage potential to the +/−contact terminals may optionally be shut off via a discharge Field Effect Transistor (FET).

FIGS. 4A (longitudinal cross-sectional view) & 4C (cut away perspective view) illustrate the housing 200 of the battery when not installed on (i.e., physically disconnected from) the secondary device 100 with the electrical members 235a, 235b, 235c, 235d separated (i.e., not engaged with) from the corresponding complementary shaped electrical connectors (e.g., receptacles) 230a, 230b, 230c, 230d. Spring-loaded pins 235b, 235c in FIGS. 4A & 4C are retained in a default state (i.e., not displaced) with the second end of the pins 235b, 235c separated a predetermined distance from the electrical contact (e.g., plate) 240 so that the electrical circuit remains open cutting off voltage potential to the communication contact terminals. Whereas, with the housing 200 of the battery when installed on (i.e., physically connected to) the secondary device 100, as shown in FIGS. 4B (longitudinal cross-sectional view) & 4D (cut away perspective view), electrical members 235a, 235b, 235c, 235d are engaged in the corresponding complementary shaped receptacle connectors 230a, 230b, 230c, 230d. With the housing of the battery 200 installed on the secondary device 100, the spring-loaded pins 235b, 235c are fully displaced interiorly within the housing 200 of the battery (compressing the respective springs 250b, 250c) so that their respective second ends directly physical contact the electrical contact 240 (e.g., plate) closing (i.e., completing) the electrical circuit supplying voltage potential to the associated communication contact terminals. Accordingly, the example of FIGS. 4A-4D prevents cutting off power to the communication contact terminals while the housing 200 of the battery is installed on (i.e., physically connected to) the secondary device 100 preventing unintended interruption in communication between the devices.

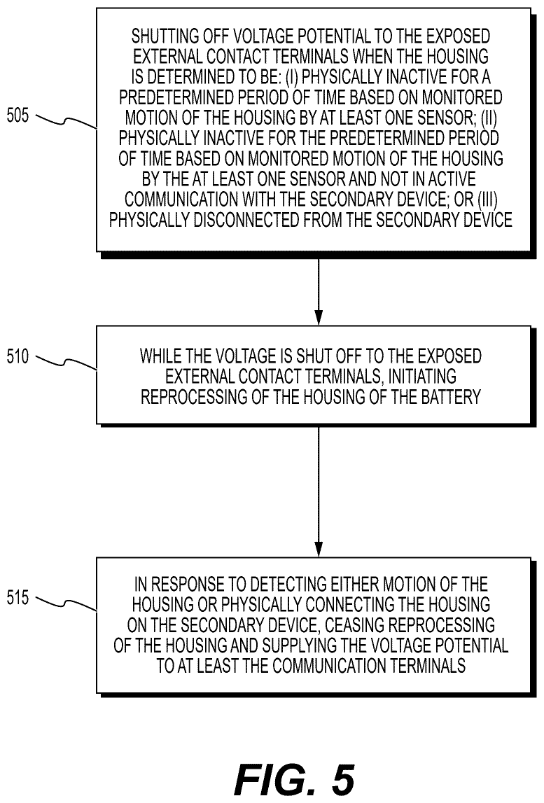

FIG. 5 is an exemplary flow chart of the method for preventing corrosion by, prior to initiating reprocessing (e.g., cleaning and/or sterilization to prevent corrosion of exposed external contact terminals), shutting off voltage potential supplied to the exposed external contact terminals of a housing of the battery when the housing of the battery is determined to be: (i) physically inactive (i.e., at rest or lack of motion) for a predetermined of time; (ii) physically inactive (i.e., at rest or lack of motion) for a predetermined of time and not in active electrical communication with the secondary device; or (iii) physically disconnected (i.e., uninstalled) from a secondary device (e.g., charger or hand-held power tool).

Initially, in step 505, the voltage potential to the exposed external contact terminals (245a, 245b, 245c, 245d) is shut off when the housing (200) is determined to be: (i) physically inactive for a predetermined period of time based on monitored motion of the housing (200) by at least one sensor (210); (ii) physically inactive for the predetermined period of time based on monitored motion of the housing (200) by the at least one sensor (210) and not in active communication with the secondary device (100); or (iii) physically disconnected from the secondary device (100). While the voltage potential is shut off to the exposed external contact terminals (245a, 245b, 245c, 245d), in step 510 reprocessing of the housing (200) is initiated.

In response to detecting either: (i) motion of the battery housing 200; or (ii) physically connecting the battery housing 200 on the secondary device 100, in step 515 reprocessing of the battery housing 200 ceases and the voltage potential is supplied to at least the communication terminals, possibly all the contact terminals.

Aspects of the present disclosure are also provided by the following numbered Clauses:
Clause 1: A method for preventing corrosion during reprocessing of a housing (200) for a battery (205) having associated exposed external contact terminals (245a, 245b, 245c) and physically connectable to a secondary device (100), wherein the exposed external contact terminals (245a, 245b, 245c, 245d) include communication contact terminals (245b, 245c) and non-communication contact terminals (245a, 245d), the method comprising the steps of: shutting off voltage potential to the exposed external contact terminals (245a, 245b, 245c, 245d) when the housing (200) is determined to be: (i) physically inactive for a predetermined period of time based on monitored motion of the housing (200) by at least one sensor (210); (ii) physically inactive for the predetermined period of time based on monitored motion of the housing (200) by the at least one sensor (210) and not in active communication with the secondary device (100); or (iii) physically disconnected from the secondary device (100); and while the voltage potential is shut off to the exposed external contact terminals (245a, 245b, 245c, 245d), initiating reprocessing of the housing (200).
Clause 2: The method of Clause 1, wherein the voltage potential is shut off to the exposed external contact terminals (245a, 245b, 245c, 245d) when the housing (200) is determined to be: (i) physically inactive for the predetermined period of time based on the monitored motion of the housing (200) by the at least one sensor (210); or (ii) physically inactive for the predetermined period of time based on the monitored motion of the housing (200) by the at least one sensor (210) and not in active communication with the secondary device (100).
Clause 3: The method of Clause 2, further comprising, in response to the motion of the housing (200) once again being detected by the at least one sensor (210), ceasing reprocessing of the housing (200) and supplying the voltage potential to at least the communication terminals (245b, 245c).
Clause 4: The method of Clause 3, wherein the voltage potential is also supplied to the non-communication contact terminals (245a, 245d).
Clause 5: The method of any of Clauses 2 through 4, wherein the at least one sensor (210) is an inertial measurement unit, an accelerometer, a gyroscope or a magnetometer.
Clause 6: The method of Clause 1, wherein the voltage potential is shut off to the exposed external contact terminals (245a, 245b, 245c, 245d) when the housing (200) is determined to be physically disconnected from the secondary device (100).
Clause 7: The method of Clause 1, wherein the determining whether the housing (200) is physically disconnected from the secondary device (100) is using a Hall sensor (225) and a magnet (220) attached to an actuating member (215) displaceable between two states.
Clause 8: The method of Clause 6, wherein the determining whether the housing (200) is physically disconnected from the secondary device (100) is based on a state of an electrical circuit associated with each of the communication contact terminals (245b, 245c) of the housing (200); wherein the secondary device (100) has electrical stationary members (230b, 230c) receiving corresponding electrical movable members (235b, 235c) associated with the housing (200); when the housing (200) is physically connected to the secondary device (100) the electrical stationary members (230b, 230c) impart a force displacing the corresponding electrical moveable members (235b, 235c) from a non-displaced state in which the electrical circuit associated with each of the communication contact terminals (245b, 245c) of the housing (200) remains in an open state shutting off the voltage supply to the communication contact terminals (245b, 245c) of the housing (200) to a fully displaced state closing the electrical circuit supplying the voltage potential to the communication contact terminals (245b, 245c) of the housing (200).
Clause 9: The method of any of Clauses 1 through 8, wherein the secondary device (100) is a charging device or a hand-held power tool.
Clause 10: The method of any of Clauses 1 through 9, wherein reprocessing is cleaning or sterilization of the housing (200).
Clause 11: A system comprising: a secondary device (100); and a housing (200) for a battery (205) having associated exposed external contact terminals (245a, 245b, 245c, 245d) including communication contact terminals (245b, 245c) and non-communication contact terminals (245a, 245d); the housing (100) being physically connectable to the secondary device (100); wherein the housing (100) includes: a processor (255) shutting off voltage potential to the exposed external contact terminals (245a, 245b, 245c, 245d) when the housing (200) is determined to be: (i) physically inactive for a predetermined period of time based on monitored motion of the housing (200) by at least one sensor (210); (ii) physically inactive for the predetermined period of time based on monitored motion of the housing (200) by the at least one sensor (210) and not in active communication with the secondary device (100); or (iii) physically disconnected from the secondary device (100); and while the voltage potential is shut off to the exposed external contact terminals (245a, 245b, 245c, 245d), the processor (255) initiates reprocessing of the housing (200).
Clause 12: The system of Clause 11, wherein the processor (255) shuts off the voltage potential to the exposed external contact terminals (245a, 245b, 245c, 245d) when the housing (200) is determined to be: (i) physically inactive for the predetermined period of time based on the monitored motion of the housing (200) by the at least one sensor (210); or (ii) physically inactive for the predetermined period of time based on the monitored motion of the housing (200) by the at least one sensor (210) and not in active communication with the secondary device (100).
Clause 13: The system of Clause 11, wherein, in response to the motion of the housing (200) once again being detected by the sensor (210), the processor (255) ceases reprocessing of the housing (200) and supplies the voltage potential to at least the communication contact terminals (245b, 245c).
Clause 14: The system of Clause 13, wherein the voltage potential is also supplied to the non-communication contact terminals (245a, 245d).
Clause 15: The system of any of Clauses 12 through 14, wherein the at least one sensor (210) is an inertial measurement unit, an accelerometer, a gyroscope or a magnetometer.
Clause 16: The system of Clause 11, wherein the voltage potential is shut off to the exposed external contact terminals (245a, 245b, 245c, 245d) when the housing (200) is determined to be physically disconnected from the secondary device (100).
Clause 17: The system of Clause 16, wherein the determining whether the housing (200) is physically disconnected from the secondary device (100) is using a Hall sensor (225) and a magnet (220) attached to an actuating member (215) displaceable between two states.
Clause 18: The system of Clause 16, wherein the determining whether the housing (200) is physically disconnected from the secondary device (100) is based on a state of an electrical circuit associated with each of the communication contact terminals (245b, 245c) of the housing (200); wherein the secondary device (100) has electrical stationary members (230b, 230c) receiving corresponding electrical movable members (235b, 235c) associated with the housing (200); when the housing (200) is physically connected to the secondary device (100) the electrical stationary members (230b, 230c) impart a force displacing the corresponding electrical moveable members (235b, 235c) from a non-displaced state in which the electrical circuit associated with each of the communication contact terminals (245b, 245c) of the housing (200) remains in an open state shutting off the voltage supply to the communication contact terminals (245b, 245c) of the housing (200) to a fully displaced state closing the electrical circuit supplying the voltage potential to the communication contact terminals (245b, 245c) of the housing (200).
Clause 19: The system of any of Clauses 11 through 18, wherein the secondary device (100) is a charging device or a hand-held power tool.
Clause 20: The system of any of Clauses 11 through 19, wherein reprocessing is cleaning or sterilization of the housing (200).

The descriptions contained herein are examples of embodiments of the present disclosure and are not intended in any way to limit the scope thereof. As described herein, the present disclosure contemplates many variations and modifications of methods for preventing corrosion of exposed external contact terminals of a housing of a battery installable on a secondary device (e.g., charger or hand-held power tool) during reprocessing (e.g., cleaning or sterilization) by beforehand shutting off voltage potential to exposed external contact terminals of the housing of the battery when it is determined that the housing of the battery is physically inactive for a predetermined period of time and, optionally, also not installed on the secondary device (e.g., charger or hand-held power tool. Several example methods for monitoring motion of the housing of the battery as well as determining whether the housing of the battery is installed on the secondary device are illustrated and described herein while other alternative ways of making such findings are contemplated. Modifications and variations apparent to those having skilled in the pertinent art according to the teachings of this disclosure are intended to be within the scope of the claims which follow.

What is claimed is:

1. A method for preventing corrosion during reprocessing of a housing for a battery having associated exposed external contact terminals and physically connectable to a secondary device, wherein the exposed external contact terminals include communication contact terminals and non-communication contact terminals, the method comprising the steps of:
shutting off voltage potential to the exposed external contact terminals when the housing is determined to be: (i) physically inactive for a predetermined period of time based on monitored motion of the housing by at least one sensor; (ii) physically inactive for the predetermined period of time based on monitored motion of the housing by the at least one sensor and not in active communication with the secondary device; or (iii) physically disconnected from the secondary device; and
while the voltage potential is shut off to the exposed external contact terminals, initiating reprocessing of the housing.

2. The method of claim 1, wherein the voltage potential is shut off to the exposed external contact terminals when the housing is determined to be:
(i) physically inactive for the predetermined period of time based on the monitored motion of the housing by the at least one sensor; or
(ii) physically inactive for the predetermined period of time based on the monitored motion of the housing by the at least one sensor and not in active communication with the secondary device.

3. The method of claim 2, further comprising, in response to the motion of the housing once again being detected by the at least one sensor, ceasing reprocessing of the housing and supplying the voltage potential to at least the communication terminals.

4. The method of claim 3, wherein the voltage potential is also supplied to the non-communication contact terminals.

5. The method of claim 2, wherein the at least one sensor is an inertial measurement unit, an accelerometer, a gyroscope or a magnetometer.

6. The method of claim 1, wherein the voltage potential is shut off to the exposed external contact terminals when the housing is determined to be physically disconnected from the secondary device.

7. The method of claim 1, wherein the determining whether the housing is physically disconnected from the secondary device is using a Hall sensor and a magnet attached to an actuating member displaceable between two states.

8. The method of claim 1, wherein the determining whether the housing is physically disconnected from the secondary device is based on a state of an electrical circuit associated with each of the communication contact terminals of the housing; wherein the secondary device has electrical stationary members receiving corresponding electrical movable members associated with the housing; when the housing is physically connected to the secondary device the electrical stationary members impart a force displacing the corresponding electrical moveable members from a non-displaced state in which the electrical circuit associated with each of the communication contact terminals of the housing remains in an open state shutting off the voltage supply to the communication contact terminals of the housing to a fully displaced state closing the electrical circuit supplying the voltage potential to the communication contact terminals of the housing.

9. The method of claim 1, wherein the secondary device is a charging device or a hand-held power tool.

10. The method of claim 1, wherein the reprocessing comprises cleaning or sterilization of the housing.

11. A system comprising:
a secondary device; and
a housing for a battery having associated exposed external contact terminals including communication contact terminals and non-communication contact terminals; the housing being physically connectable to the secondary device; wherein the housing includes a processor configured to:
shut off voltage potential to the exposed external contact terminals when the housing is determined to be: (i) physically inactive for a predetermined period of time based on monitored motion of the housing by at least one sensor; (ii) physically inactive for the predetermined period of time based on monitored motion of the housing by the at least one sensor and not in active communication with the secondary device; or (iii) physically disconnected from the secondary device; and
while the voltage potential is shut off to the exposed external contact terminals, initiate reprocessing of the housing.

12. The system of claim 11, wherein the processor is configured to shut off the voltage potential to the exposed external contact terminals when the housing is determined to be: (i) physically inactive for the predetermined period of time based on the monitored motion of the housing by the at least one sensor; or (ii) physically inactive for the predetermined period of time based on the monitored motion of the housing by the at least one sensor and not in active communication with the secondary device.

13. The system of claim 11, wherein, in response to the motion of the housing once again being detected by the sensor, the processor is configured to cease reprocessing of the housing and supply the voltage potential to at least the communication contact terminals.

14. The system of claim 13, wherein the voltage potential is also supplied to the non-communication contact terminals.

15. The system of claim 12, wherein the at least one sensor is an inertial measurement unit, an accelerometer, a gyroscope or a magnetometer.

16. The system of claim 11, wherein the processor is configured to shut off the voltage potential to the exposed external contact terminals when the housing is determined to be physically disconnected from the secondary device.

17. The system of claim 16, wherein the determining whether the housing is physically disconnected from the secondary device comprises using a Hall sensor and a magnet attached to an actuating member displaceable between two states.

18. The system of claim 16, wherein the determining whether the housing is physically disconnected from the secondary device is based on a state of an electrical circuit associated with each of the communication contact terminals of the housing; wherein the secondary device includes electrical stationary members receiving corresponding electrical movable members associated with the housing; when the housing is physically connected to the secondary device the electrical stationary members impart a force displacing the corresponding electrical moveable members from a non-displaced state in which the electrical circuit associated with each of the communication contact terminals of the housing remains in an open state shutting off the voltage supply to the communication contact terminals of the housing to a fully displaced state closing the electrical circuit supplying the voltage potential to the communication contact terminals of the housing.

19. The system of any of claim 11, wherein the secondary device is a charging device or a hand-held power tool.

20. The system of claim 11, wherein the reprocessing comprises cleaning or sterilization of the housing.
